(19) United States
(12) Patent Application Publication
(10) Pub. No.: US 2020/0156608 A1
(43) Pub. Date: May 21, 2020

(54) VEHICLE HAVING ELECTRIC MOTOR AND BRAKING CONTROL METHOD FOR THE SAME

(71) Applicants: HYUNDAI MOTOR COMPANY, Seoul (KR); KIA MOTORS CORPORATION, Seoul (KR)

(72) Inventors: Sung Bae Jeon, Ansan-si (KR); Jin Kyeom Cho, Suwon-si (KR); Hui Un Son, Suwon-si (KR)

(21) Appl. No.: 16/540,640

(22) Filed: Aug. 14, 2019

(30) Foreign Application Priority Data
Nov. 20, 2018 (KR) 10-2018-0143443

(51) Int. Cl. B60T 8/1755; B60T 8/176; B60W 30/18

(52) U.S. Cl. CPC B60T 8/17551; B60W 30/18109; B60T 8/176

(57) ABSTRACT

A braking control method for a vehicle having a motor includes: determining the braking torque required by each wheel; determining the motor braking torque to be provided by the motor based on the braking torque required by each wheel and the maximum torque of the motor; and determining the hydraulic braking torque of each wheel to be provided by a hydraulic anti-lock braking system (ABS) brake based on the braking torque required by each wheel and the motor braking torque.

This application claims the benefit of Korean Patent Application No. 10-2018-0143443, filed on Nov. 20, 2018 in the Korean Intellectual Property Office, which is hereby incorporated by reference as if fully set forth herein.

### TECHNICAL FIELD

The present disclosure relates to a vehicle having an electric motor, which may stably track a target slip ratio when a braking operation is performed, and a braking control method for the same.

### BACKGROUND

In vehicles, driving performance based on driving force is important. Braking performance is also important in order to ensure safe driving. Therefore, research is constantly being conducted with the goal of improving the braking performance of vehicles.

One of the representative devices for improving braking performance is an anti-lock braking system (ABS). The ABS is a brake system developed to prevent wheels of a vehicle from locking up during rapid braking. The construction and operational principle of the ABS will be described below with reference to FIG. 1.

FIG. 1 is a view showing the construction of a conventional ABS.

Referring to FIG. 1, a hydraulic pump 11 maintains the pressure of a first fluid passage 12. In this state, when a driver operates a brake pedal 13, a master cylinder 14 increases the pressure of the first fluid passage 12. When operation of the ABS is required depending on the braking condition and the operation amount of the brake pedal 13 by the driver, an apply valve 15 and a dump valve 17 are alternately and repeatedly opened and closed. When the apply valve 15 is opened and the dump valve 17 is closed, the pressure of the first fluid passage 12 is transmitted to a brake 16, and a caliper comes into contact with a brake disc. On the other hand, when the apply valve 15 is closed and the dump valve 17 is opened, the pressure applied to the brake 16 moves to a second fluid passage 18 via the dump valve 17. Thus, during the operation of the ABS, contact and separation of the caliper of the brake 16 with and from the brake disc are repeatedly performed for a short time, thereby preventing lock-up of the wheels.

Next, the control region of the ABS will be described below with reference to FIG. 2. FIG. 2 is a view showing the relationship between a braking slip ratio and a braking force coefficient in various situations.

Referring to FIG. 2, the braking force coefficient depending on a braking slip ratio has different values depending on the kinds of tires and the road surface conditions. However, in general, the braking force coefficient is maximized when the slip ratio is in the range of 40% or lower. As such, the control region of the ABS corresponds to a region in which the slip ratio ranges from 8% to 35%, and the control process is generally performed about four to ten times every second, without limitation thereto.

In general, a hybrid electric vehicle (HEV) is a vehicle that uses two kinds of power sources, typically including an engine and an electric motor. In recent years, extensive research has been conducted into hybrid electric vehicles, since hybrid electric vehicles exhibit higher fuel economy, higher power performance, and lower discharge of exhaust gas than vehicles having only internal combustion engines.

A hybrid electric vehicle may operate in two traveling modes based on the powertrain thereof. One of the traveling modes is an electric vehicle (EV) mode, in which the hybrid electric vehicle is driven using only the electric motor, and another is a hybrid electric vehicle (HEV) mode, in which the hybrid electric vehicle is driven using both the electric motor and the engine. Based on the traveling conditions, the hybrid electric vehicle switches between the two modes.

Switching between the two driving modes is generally performed in order to maximize fuel efficiency or driving efficiency based on the efficiency characteristics of the powertrain.

The construction of the hybrid electric vehicle will be described below with reference to FIG. 3. FIG. 3 is a view showing an example of the structure of the powertrain of a general parallel-type hybrid electric vehicle.

Referring to FIG. 3, the powertrain of the hybrid electric vehicle adopts a parallel-type hybrid system, in which an electric motor (or a drive motor) 140 and an engine clutch (EC) 130 are installed between an internal combustion engine (ICE) 110 and a transmission 150.

In such a vehicle, when a driver steps on an accelerator after starting, the motor 140 is first driven using electric power from a battery in the state in which the engine clutch 130 is open, and then power from the motor is transmitted to the wheels via the transmission 150 and a final drive (FD) 160 in order to rotate the wheels (i.e. an EV mode). When higher driving force is needed as the vehicle is gradually accelerated, an auxiliary motor (or a starter/generator motor) 120 may be operated in order to drive the engine 110.

When the rotational speeds of the engine 110 and the motor 140 become equal, the engine clutch 130 is locked, with the result that both the engine 110 and the motor 140 or the engine 110 alone drives the vehicle (i.e. transition from the EV mode to an HEV mode). When a predetermined engine OFF condition is satisfied, for example, when the vehicle decelerates, the engine clutch 130 is opened, and the engine 110 is stopped (i.e. transition from the HEV mode to the EV mode). In addition, in the hybrid electric vehicle, during the braking operation, the battery is charged by conversion of the driving force of the wheels into electric energy, which is referred to as recovery of braking energy or regenerative braking.

The starter/generator motor 120 acts as a start motor when starting the engine and as a generator after starting the engine, at the time of starting off, or when engine rotation energy is collected. Therefore, the starter/generator motor 120 may be referred to as a “hybrid start generator (HSG)”, or may also be referred to as an “auxiliary motor” as needed.

A hybrid electric vehicle is generally equipped with an ABS. However, there have been attempts to replace the ABS function with an electric motor. An electric motor is capable not only of performing a greater variety of control operations compared to a general ABS, which alternately operates a plurality of valves, but also of achieving rapid control with a high bandwidth of up to 100 Hz.

However, in order to completely replace the ABS with an electric motor, it is necessary to independently distribute torque to both wheels. Thus, the replacement may be implemented only in an in-wheel driving system, in which a motor is installed in each of the wheels, but may not be possible to implement in the parallel-type hybrid system shown in FIG. 3. The parallel-type hybrid electric vehicle is constructed such that a differential having a differential gear is disposed at the rear end of the FD 160, thus making it impossible to independently distribute torque to both wheels.

Therefore, there is demand for a method of improving the braking performance of a parallel-type hybrid electric vehicle using an electric motor having excellent control responsiveness.

### SUMMARY

The present disclosure is directed to a vehicle having an electric motor and a braking control method for the same that substantially obviate one or more problems due to the limitations and disadvantages of the related art.

An object of the present disclosure is to provide a hybrid electric vehicle that is capable of improving braking performance using an electric motor and a control method thereof.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

In accordance with an exemplary embodiment of the present disclosure, a braking control method for a vehicle having a motor includes: determining the braking torque required by each wheel; determining the motor braking torque to be provided by the motor based on the braking torque required by each wheel and the maximum torque of the motor; and determining the hydraulic braking torque of each wheel to be provided by a hydraulic anti-lock braking system (ABS) brake based on the braking torque required by each wheel and the motor braking torque.

In accordance with another exemplary embodiment of the present disclosure, a vehicle includes: an electric motor, a hydraulic anti-lock braking system (ABS) brake, and a controller configured to control operation of the electric motor and the hydraulic ABS brake, wherein the controller includes an ABS operation determining processor configured to determine the braking torque required by each wheel, a motor braking torque calculator configured to determine the motor braking torque to be provided by the motor based on the braking torque required by each wheel and the maximum torque of the motor, and a hydraulic braking torque calculator configured to determine the hydraulic braking torque of each wheel to be provided by the hydraulic ABS brake based on the braking torque required by each wheel and the motor braking torque.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a view showing the construction of a conventional ABS;

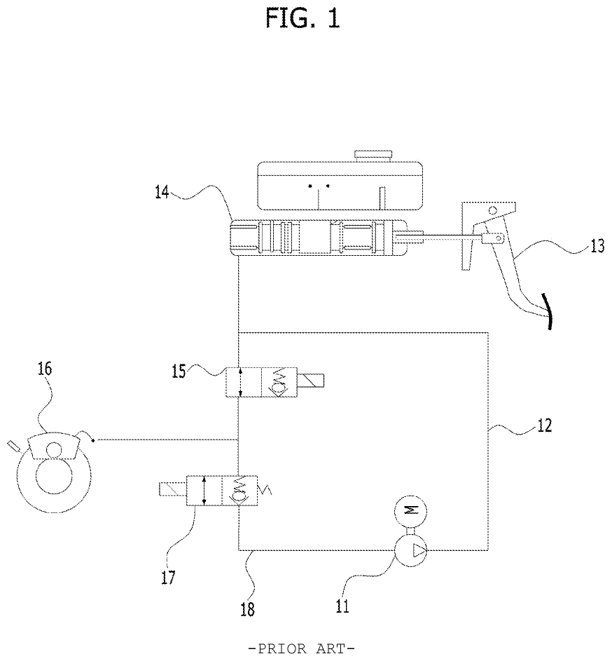

FIG. 2 is a view showing the relationship between a braking slip ratio and a braking force coefficient in various situations;

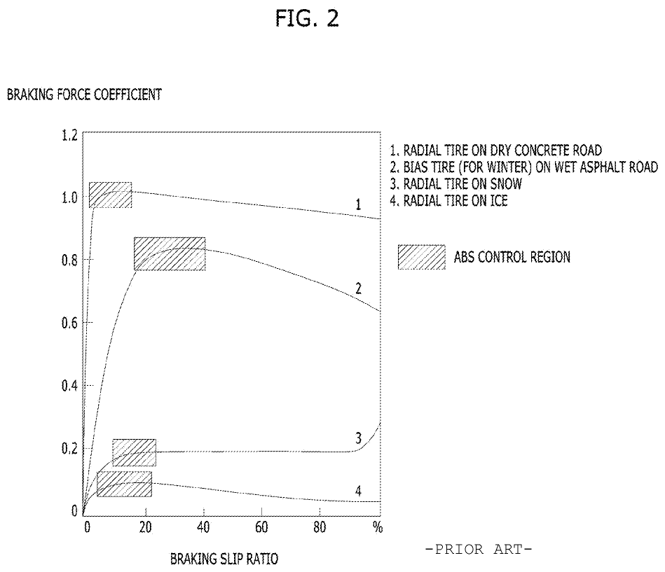

FIG. 3 is a view showing an example of the structure of a powertrain of a general parallel-type hybrid electric vehicle;

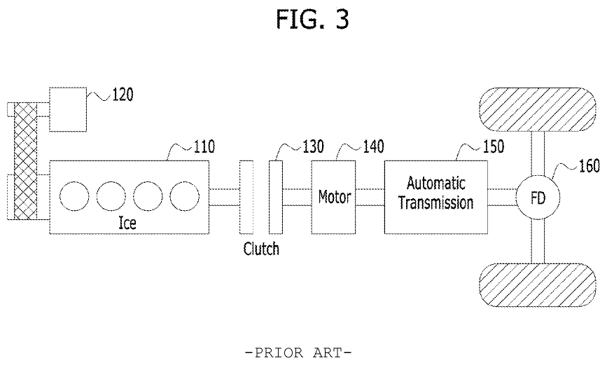

FIG. 4 is a view showing an example of the construction of a vehicle system according to an exemplary embodiment of the present disclosure;

FIG. 5 is a view showing an example of the operation logic of an ABS operation determining processor according to an exemplary embodiment of the present disclosure;

FIG. 6 is a view showing an example of the operation logic of a motor braking torque calculator according to an exemplary embodiment of the present disclosure;

FIG. 7 is a view showing an example of the operation logic of a hydraulic braking torque calculator according to an exemplary embodiment of the present disclosure;

FIG. 8 is a flowchart showing an example of a braking control process according to an exemplary embodiment of the present disclosure; and

FIG. 9 is a view showing the comparison between the braking performance of the braking control process according to an exemplary embodiment of the present disclosure and the braking performance of a conventional ABS.

### DETAILED DESCRIPTION

Hereinafter, exemplary embodiments of the present disclosure will be described in detail with reference to the accompanying drawings so as for those skilled in the art to easily carry out the embodiments. The present disclosure may, however, be embodied in many different forms, and should not be construed as being limited to the embodiments set forth herein. In the drawings, parts irrelevant to the description of the present disclosure will be omitted for clarity. Like reference numerals refer to like elements throughout the specification.

Throughout the specification, unless explicitly described to the contrary, the word “include” and variations such as “includes” or “including” will be understood to imply the inclusion of stated elements but not the exclusion of any other elements. In addition, the same reference numerals used throughout the specification refer to the same constituent elements.

The embodiment of the present disclosure provides a vehicle having an improved ABS function by calculating the braking torque required by each wheel, causing a motor to provide the torque that is to be equally applied to both wheels via a differential, and causing a hydraulic brake to provide the torque that is to be independently applied to each of the wheels.

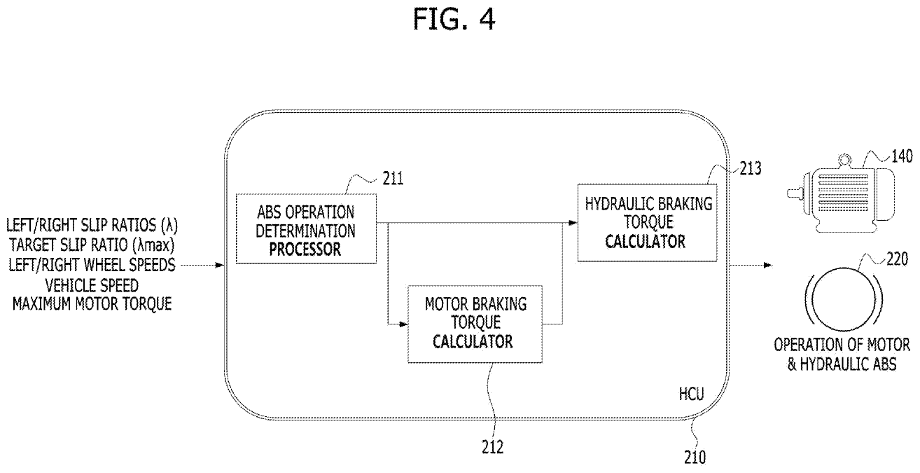

First, the construction of a system for performing braking control according to the embodiment will be described below with reference to FIG. 4. FIG. 4 is a view showing an example of the construction of a vehicle system according to an exemplary embodiment of the present disclosure.

Referring to FIG. 4, a vehicle having an electric motor according to an exemplary embodiment of the present disclosure may include an electric motor 140 configured to provide a part of braking force during the operation of an anti-lock braking system (ABS), a hydraulic brake 220 equipped with the ABS and configured to provide another part of the braking force, and a controller 210 configured to control the operation of the electric motor 140 and the hydraulic brake 220, i.e. to determine the braking force that each of the electric motor 140 and the hydraulic brake 220 provides.

The controller 210 may receive, as input values, slip ratios λ of the left/right wheels, a target slip ratio Amax causing a coefficient of friction to be maximized, speeds of the left/right wheels, a vehicle speed, and the maximum torque of the motor 140. The controller 210 may be a control unit capable of acquiring all of the above information. In the case of a hybrid electric vehicle (HEV), the controller 210 may be a hybrid control unit (HCU), which is a high-level control unit that performs overall control of an engine control unit and a motor control unit. In the case of an electric vehicle (EV), the controller 210 may be a vehicle control unit (VCU), which corresponds to an HCU. However, the present disclosure is not limited thereto.

The controller 210 may include an ABS operation determining processor 211, which calculates the braking torque required by each wheel so as to track a target slip ratio (the slip ratio at which p is maximized), a motor braking torque calculator 212, which calculates the braking torque that the motor 140 is to provide, and a hydraulic braking torque calculator 213, which calculates the braking torque that the hydraulic brake 220 is to provide.

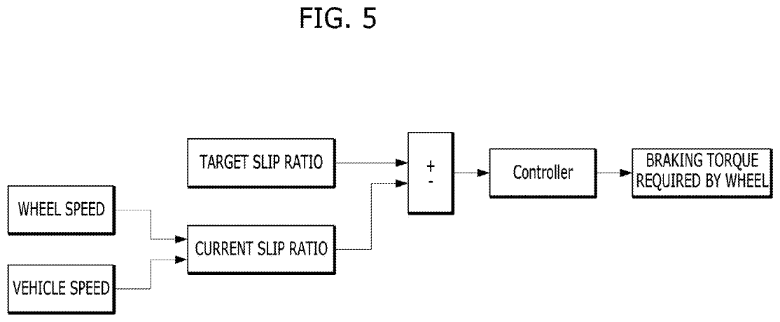

Hereinafter, the functions of the respective components 211, 212 and 213 included in the controller 210 will be described in detail with reference to FIGS. 5 to 7.

FIG. 5 is a view showing an example of the operation logic of the ABS operation determining processor according to an exemplary embodiment of the present disclosure.

Referring to FIG. 5, the ABS operation determining processor 211 calculates the braking torque required by each wheel so as to track a target slip ratio (the slip ratio at which μ is maximized). To this end, the ABS operation determining processor 211 calculates the current slip ratio based on the speed of each wheel and the vehicle speed. After the current slip ratio of each wheel is calculated, the braking torque required by each wheel may be calculated in order to compensate for the difference with the target slip ratio. For example, the current slip ratio may be calculated as follows: “1−u(1)/(u(2)+(u(2)==0)*eps)”. Here, u(1) may represent the rotating angular speed of a specific wheel, and u(2) may represent the angular speed of the vehicle (based on the vehicle speed and the radius of the wheel). In other words, the current slip ratio may be calculated as follows: “1-(angular speed of wheel/angular speed of vehicle)”. Thus, when the angular speed of the wheel and the angular speed of the vehicle are equal to each other, the slip ratio of the corresponding wheel is 0. (u(2)==0)*eps may represent a term for substituting a denominator of 0 with a minimum computable number in order to prevent the function, having the form of a fraction, from approaching infinity when the denominator approaches 0.

The process of calculating the required braking torque, which is shown in FIG. 5, may be performed when intervention by the ABS is necessary. When the difference between the target slip ratio and the current slip ratio is equal to or greater than a predetermined value, the ABS operation determining processor 211 may determine that intervention by the ABS is necessary. Here, the predetermined value may be set differently for each vehicle depending on the braking capacity of the hydraulic brake and the maximum torque of the motor thereof.

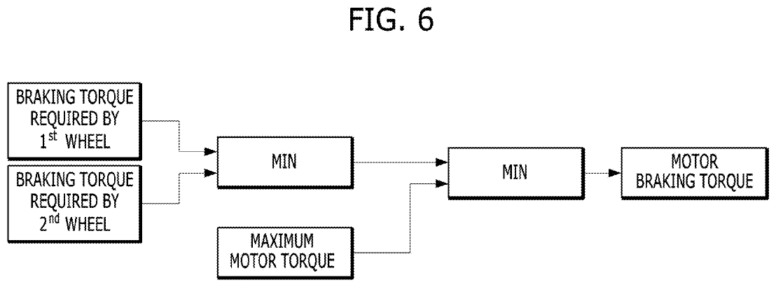

FIG. 6 is a view showing an example of the operation logic of the motor braking torque calculator according to an embodiment of the present disclosure.

Referring to FIG. 6, the motor braking torque calculator 212 may calculate a common part of the torques required by both wheels and may determine the motor braking torque within a range within which the calculated common part does not exceed the maximum motor torque.

Specifically, in the process of calculating the common part of the torques required by both wheels, the smaller value Min of the braking torque required by a first wheel and the braking torque required by a second wheel may be determined as the commonly required braking torque. Alternatively, the smaller value Min of the commonly required braking torque and the maximum motor torque may be determined as the motor braking torque.

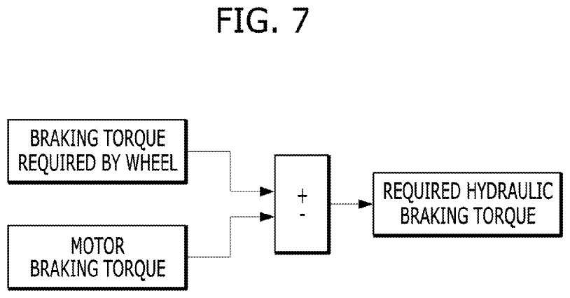

FIG. 7 is a view showing an example of the operation logic of the hydraulic braking torque calculator according to an exemplary embodiment of the present disclosure.

Referring to FIG. 7, the hydraulic braking torque calculator 213 may determine the part of the braking torque required by each wheel, other than the motor braking torque that the motor is to provide, to be the hydraulic braking torque required by each wheel. In other words, the hydraulic braking torque calculator 213 may calculate the hydraulic braking torque required by each wheel by subtracting the motor braking torque from the braking torque required by each wheel.

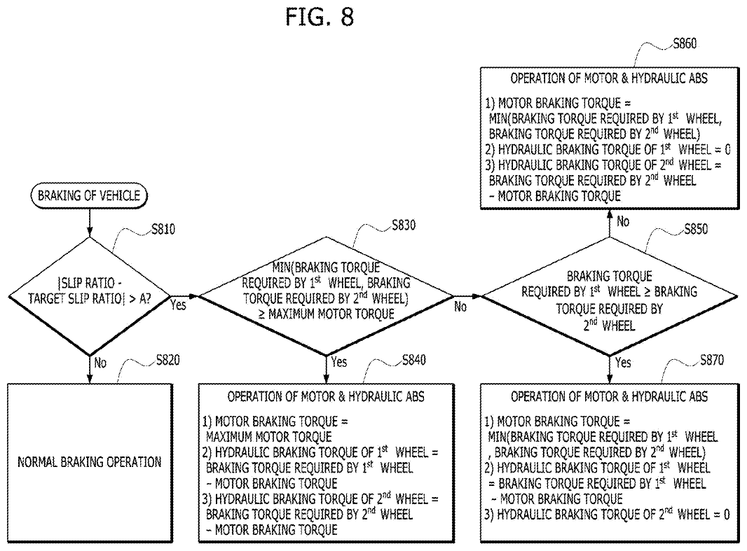

The braking control process described above will be explained below with reference to the flowchart in FIG. 8.

FIG. 8 is a flowchart showing an example of the braking control process according to an exemplary embodiment of the present disclosure.

Referring to FIG. 8, as the braking operation of the vehicle is performed, the ABS operation determining processor 211 may determine whether the difference between the current slip ratio and the target slip ratio causing a coefficient of friction to be maximized exceeds a predetermined value a (S810).

If the difference between the two slip ratios is equal to or less than the predetermined value (No at S810), the ABS operation determining processor 211 may determine that intervention by the ABS is not necessary and may perform control such that normal braking operation is performed without operation of the ABS (S820). Here, “normal braking” may represent normal hydraulic braking, regenerative braking using the motor 140, or a combination thereof. To this end, the controller 210 may determine the braking torque of the motor 140 and the braking torque of the hydraulic brake 220 based on the state of charge (SOC) of the battery driving the motor 140 and the required braking force. For example, in the case of full SOC, regenerative braking is not performed, but only hydraulic braking is performed. Regardless of the SOC, if the required braking torque exceeds the maximum torque of the motor, the excess may be provided by hydraulic braking.

On the other hand, if the difference between the two slip ratios exceeds the predetermined value (Yes at S810), the motor 140 and the ABS may be operated together for braking.

Specifically, the ABS operation determining processor 211 may determine the braking torque required by each wheel for tracking the target slip ratio, and the motor braking torque calculator 212 may determine, based on the determination result of the ABS operation determining processor 211, whether the smaller value of the braking torques required by the wheels is equal to or greater than the maximum motor torque (S830).

If the smaller value of the braking torques required by the wheels is equal to or greater than the maximum motor torque (Yes at S830), the motor braking torque calculator 212 may determine the motor braking torque as the maximum motor torque, and the hydraulic braking torque calculator 213 may determine the hydraulic braking torque of each wheel by subtracting the motor braking torque (i.e. the maximum motor torque) from the braking torque required by each wheel (S840).

If the smaller value of the braking torques required by the wheels is less than the maximum motor torque (No at S830), it may be determined whether the braking torque required by the first wheel is equal to or greater than the braking torque required by the second wheel (S850).

If the braking torque required by the first wheel is less than the braking torque required by the second wheel (No at S850), the motor braking torque calculator 212 may determine the smaller value of the braking torques required by the wheels as the motor braking torque, and the hydraulic braking torque calculator 213 may determine the hydraulic braking torque of the first wheel as 0 and may determine the hydraulic braking torque of the second wheel by subtracting the motor braking torque from the braking torque required by the second wheel (S860).

On the other hand, if the braking torque required by the first wheel is equal to or greater than the braking torque required by the second wheel (Yes at S850), the motor braking torque calculator 212 may determine the smaller value of the braking torques required by the wheels as the motor braking torque, and the hydraulic braking torque calculator 213 may determine the hydraulic braking torque of the second wheel as 0 and may determine the hydraulic braking torque of the first wheel by subtracting the motor braking torque from the braking torque required by the first wheel (S870).

The process shown in FIG. 8 may be continuously carried out at regular calculation periods. The calculation period may be determined in consideration of a motor control bandwidth. If the calculation period is sufficiently short, the control process may be performed a number of times corresponding to the motor control bandwidth every second. Thus, it is possible to maximize the efficiency of tracking the target slip ratio at which each wheel has the maximum braking force coefficient.

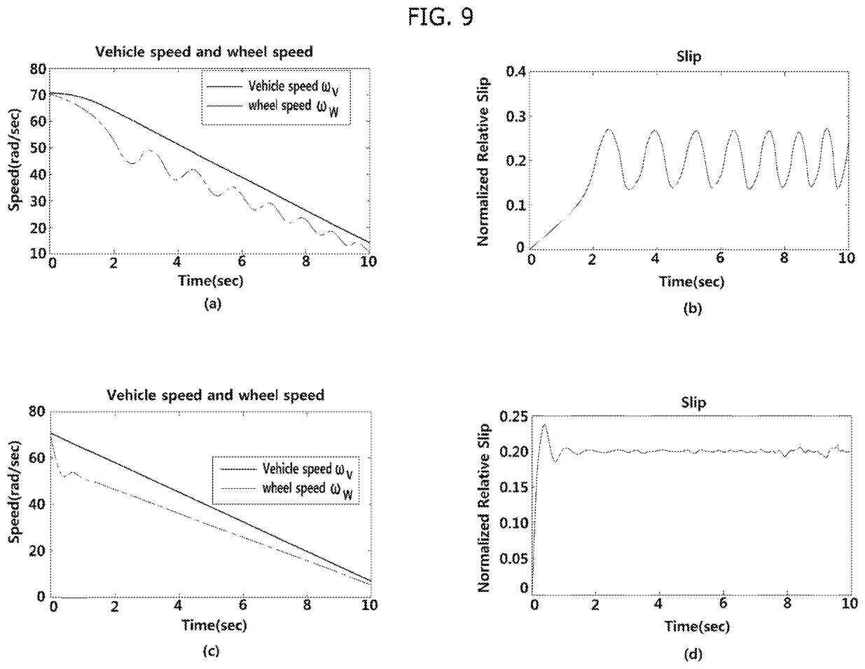

The effects obtained by performing the above braking control process will be described below with reference to FIG. 9.

FIG. 9 is a view showing the comparison between the braking performance of the braking control process according to an exemplary embodiment of the present disclosure and the braking performance of a conventional ABS.

FIG. 9 shows the results of simulations performed through modeling in order to compare the braking effects when using both the motor and the hydraulic ABS according to the embodiment and when using only a conventional ABS. The simulations were performed under the condition of application of different disturbances to both wheels in order to generate different braking torques required for the wheels and the condition of the target slip ratio of 0.2, at which the braking force coefficient is maximized.

FIG. 9A shows changes in the vehicle speed and the wheel speed over time during braking using only the hydraulic ABS, and FIG. 9B shows a change in the slip ratio over time during braking using only the hydraulic ABS. FIG. 9C shows changes in the vehicle speed and the wheel speed over time during braking when performing the braking control according to the present disclosure, and FIG. 9D shows a change in the slip ratio over time during braking when performing the braking control according to the present disclosure.

Referring to FIG. 9A, when only the ABS is used, the wheel speed is reduced while fluctuating, i.e. repeatedly increasing and decreasing according to the control period of the ABS. Referring to FIG. 9C, when braking control according to the present disclosure is performed, the wheel speed is reduced uniformly.

Referring to FIG. 9B, when only the ABS is used, the slip ratio reaches the target slip ratio, which is 0.2, in 2 seconds, and thereafter fluctuates between 0.1 and 0.3 (i.e. a control error occurs). Referring to FIG. 9D, when braking control according to the present disclosure is performed, the slip ratio reaches the target slip ratio within 1 second, and thereafter constantly tracks the target slip ratio.

As described above, braking control according to the present disclosure greatly improves a response speed and tracking efficiency in achieving the target slip ratio compared to braking operation using a conventional hydraulic ABS.

The present disclosure described above may be implemented as a computer-readable code of a computer-readable medium in which programs are recorded. The computer-readable medium includes all kinds of recording devices in which data that may be read by a computer system is stored. Examples of the computer-readable medium may include a hard disk drive (HDD), a solid-state disk (SSD), a silicon disk drive (SDD), ROM, RAM, a CD-ROM, a magnetic tape, a floppy disk, and an optical data storage device.

As is apparent from the above description, a hybrid electrode vehicle related to at least one embodiment of the present disclosure constructed as described above may have improved braking performance.

In particular, the braking force to be equally applied to both wheels is provided by a motor, and only surplus braking force is provided by an ABS. As a result, the efficiency of tracking a target slip ratio is improved by the responsiveness of the motor.

It will be appreciated by those skilled in the art that the effects achievable through the present disclosure are not limited to those that have been specifically described hereinabove, and other effects of the present disclosure will be more clearly understood from the detailed description above.

Accordingly, the detailed description above is not intended to be construed to limit the present disclosure in all aspects, but is to be considered by way of example. The scope of the present disclosure should be determined by reasonable interpretation of the accompanying claims, and all equivalent modifications made without departing from the scope of the present disclosure should be included in the following claims.

What is claimed is:

1. A braking control method for a vehicle having a motor, the method comprising:
determining a braking torque required by each wheel;
determining a motor braking torque to be provided by the motor based on the braking torque required by each wheel and a maximum torque of the motor; and
determining a hydraulic braking torque of each wheel to be provided by a hydraulic anti-lock braking system (ABS) brake based on the braking torque required by each wheel and the motor braking torque.

2. The method according to claim 1, further comprising:
calculating a current slip ratio based on a speed of each wheel and a vehicle speed,
wherein the determining the braking torque required by each wheel is performed based on the current slip ratio and a target slip ratio.

3. The method according to claim 2, wherein the target slip ratio corresponds to a slip ratio at which a braking force coefficient is maximized.

4. The method according to claim 2, further comprising:
determining whether intervention by the hydraulic ABS brake is necessary based on a difference between the current slip ratio and the target slip ratio.

5. The method according to claim 4, further comprising:
upon determining that intervention by the hydraulic ABS brake is not necessary, performing at least one of hydraulic braking or regenerative braking.

6. The method according to claim 1, wherein the determining the motor braking torque comprises determining a smaller value of the braking torque required by each wheel and the maximum torque of the motor as the motor braking torque.

7. The method according to claim 1, wherein the determining the hydraulic braking torque of each wheel comprises subtracting the motor braking torque from the braking torque required by each wheel.

8. The method according to claim 1, wherein, when the maximum torque of the motor is greater than the braking torque required by each wheel,
a braking torque required by a wheel having a smallest value of the braking torque required by each wheel is the motor braking torque, and
a hydraulic braking torque of the wheel having the smallest value of the braking torque required by each wheel is 0.

9. The method according to claim 1, wherein, when the maximum torque of the motor is equal to or less than the braking torque required by each wheel,
the motor braking torque is the maximum torque of the motor, and
the hydraulic braking torque of each wheel is a value obtained by subtracting the maximum torque of the motor from the braking torque required by each wheel.

10. A non-transitory computer-readable recording medium having recorded therein a program for causing a computer to execute the braking control method for a vehicle having a motor described in claim 1.

11. A vehicle comprising:
an electric motor;
a hydraulic anti-lock braking system (ABS) brake; and
a controller configured to control operation of the electric motor and the hydraulic ABS brake,
wherein the controller comprises:
an ABS operation determining processor configured to determine a braking torque required by each wheel;
a motor braking torque calculator configured to determine a motor braking torque to be provided by the motor based on the braking torque required by each wheel and a maximum torque of the motor; and
a hydraulic braking torque calculator configured to determine a hydraulic braking torque of each wheel to be provided by the hydraulic ABS brake based on the braking torque required by each wheel and the motor braking torque.

12. The vehicle according to claim 11, wherein the ABS operation determining processor calculates a current slip ratio based on a speed of each wheel and a vehicle speed and determines the braking torque required by each wheel based on the current slip ratio and a target slip ratio.

13. The vehicle according to claim 12, wherein the target slip ratio corresponds to a slip ratio at which a braking force coefficient is maximized.

14. The vehicle according to claim 12, wherein the ABS operation determining processor determines whether intervention by the hydraulic ABS brake is necessary based on a difference between the current slip ratio and the target slip ratio.

15. The vehicle according to claim 14, wherein, when it is determined that intervention by the hydraulic ABS brake is not necessary, the controller performs control such that at least one of hydraulic braking or regenerative braking is performed.

16. The vehicle according to claim 11, wherein the motor braking torque calculator determines a smaller value of the braking torque required by each wheel and the maximum torque of the motor as the motor braking torque.

17. The vehicle according to claim 11, wherein the hydraulic braking torque calculator determines the hydraulic braking torque of each wheel by subtracting the motor braking torque from the braking torque required by each wheel.

18. The vehicle according to claim 11, wherein, when the maximum torque of the motor is greater than the braking torque required by each wheel,
a braking torque required by a wheel having a smallest value of the braking torque required by each wheel is the motor braking torque, and
a hydraulic braking torque of the wheel having the smallest value of the braking torque required by each wheel is 0.

19. The vehicle according to claim 11, wherein, when the maximum torque of the motor is equal to or less than the braking torque required by each wheel,
the motor braking torque is the maximum torque of the motor, and
the hydraulic braking torque of each wheel is a value obtained by subtracting the maximum torque of the motor from the braking torque required by each wheel.
